(19) United States
(12) Patent Application Publication
(10) Pub. No.: US 2008/0138047 A1
(43) Pub. Date: Jun. 12, 2008

(54) Information processing device

(75) Inventor: Masaya Kanayama, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kanagawa (JP)

(21) Appl. No.: 11/980,625

(22) Filed: Oct. 31, 2007

(30) Foreign Application Priority Data
Nov. 1, 2006 (JP) 2006-298018

(51) Int. Cl. H04N 7/26

(52) U.S. Cl. 386/124

(57) ABSTRACT

An information processing device comprises two or more tuners, a counter for reproduction and a counter for recording, provided for managing time for a received side, and a synchronization control section to control a reproducing clock and a recording clock for reproducing and recording received data received via the tuners respectively, so as to synchronize with a transmission side based on time information added to the received packet and a count value of the counter for reproduction or the counter for recording.

### BACKGROUND OF THE INVENTION

1. Field of the Invention

The present invention relates to an information processing device for receiving data from a tuner, and viewing and recording the data.

2. Description of the Related Art

When an MPEG (Moving Picture Experts Group) transport stream (TS), which is received, is reproduced in real-time, the reception side establishes synchronization based on reference clock synchronization with the transmission side clock, and executes various reproduction processings. In this case, the reception side needs a synchronization system for synchronizing its own clock with the transmission side clock.

To reproduce an MPEG TS or MPEG program stream (PS), for example, which are recorded in a recording medium, the reception side normally establishes synchronization based on a reference clock of which frequency is fixed, and which is generated by a crystal oscillator, and executes various reproduction processings. In this case, a self complete synchronization system is required.

In a reproducing device which can perform reproduction using both a transmission synchronization system (transmission reproduction) and reproduction using a storage synchronization system (storage reproduction), a transmission synchronization system and a storage synchronization system are independently provided. In this case, however, if the reproduction mode is switched from transmission reproduction to storage reproduction, or from storage reproduction to transmission reproduction, the synchronization system is also switched. This causes a problem with synchronization, and disturbs reproduced images at transition. With this in view, Japanese Unexamined Patent Application Publication No. 2003-244697 (Hamada et al.) discloses a recording/reproducing device which does not disturb reproduced images when reproduction mode is switched.

FIG. 20 is a diagram showing a recording/reproducing device disclosed in Hamada et al. As FIG. 20 shows, a BS/CS digital tuner 101 receives a digital television broadcast transmitted via a broadcasting satellite or communications satellite, demodulates it, and supplies MPEG TS encoded conforming to the MPEG 2 standard of a selected channel to a selector 105. A ground wave digital tuner 102 demodulates a received ground wave, and supplies the MPEG TS of the selected channel to the selector 105. An Ethernet®/radio LAN interface 103 supplies MPEG TS received from the Ethernet® or radio LAN to the selector 105. An IEEE 1394 interface 104 supplies MPEG TS received via a network of IEEE 1394 interfaces to the selector 105.

When MPEG TS is recorded in a recording medium, which is not illustrated, the selector 105 selects MPEG TS to be recorded, and supplies it to a buffer controller 106. When MPEG TS is reproduced in real-time (transmission reproduction), the selector 105 selects MPEG TS to be reproduced, and supplies it to a demultiplexer 108. Further, when MPEG TS, recorded in a storage medium, is storage-reproduced, the selector 105 supplies MPEG TS, supplied from the buffer controller 106, to the demultiplexer 108.

In recording, the buffer controller 106 outputs MPEG TS, which is input from the selector 105, to a storage device 107 at a transfer rate and timing corresponding to the recording medium, and records it in the recording medium. In reproduction, the buffer controller 106 supplies MPEG TS, read from the recording medium and supplied by the storage device 107, to the selector 105.

The demultiplexer 108 extracts a PES (Packetized Elementary Stream) packet from the MPEG TS supplied from the selector 105, and supplies it to an MPEG AV decoder 109. The demultiplexer 108 also extracts a PCR (Program Clock Reference) from the MPEG TS, and supplies it to a PLL (Phase Lock Loop) circuit 113.

The MPEG AV decoder 109 establishes frame synchronization using a synchronization signal supplied from a synchronization signal generation circuit 117, and generates a video elementary stream and voice elementary stream from the PES packet supplied from the demultiplexer 108. The MPEG AV decoder 109 also decodes the image elementary stream according to the clock for video signal processing, which is supplied from the PLL circuit 115, and supplies the video data acquired as the result to a post video signal processing circuit 110. The MPEG AV decoder 109 also decodes the voice elementary stream according to the clock for audio signal processing, which is supplied from the PLL circuit 116, and supplies the voice data, which is acquired as the result, to a D/A conversion circuit 112.

The post video signal processing circuit 110 establishes frame synchronization using a synchronization signal supplied from the synchronization signal generation circuit 117, and performs digital effect processing and noise filter processing for the video data which is input from the MPEG AV decoder 109 according to the clock for video signal processing, which is supplied from a PLL circuit 115. And the post video signal processing circuit 110 supplies the signal acquired after performing various processings to a D/A conversion circuit 111.

The D/A conversion circuit 111 establishes synchronization using a synchronization signal supplied from the synchronization signal generation circuit 117, D/A converts the digital video signal (digital component signal), which is input according to the clock for video signal processing supplied from the PLL circuit 115, into an analog signal, and outputs an analog component video signal acquired as the result to an external device. The D/A conversion circuit 111 also converts the digital voice signal, which is input from the MPEG AV decoder 109, into an analog stereo voice signal, and outputs it to an external device according to a clock for audio signal processing, which is supplied from a PLL circuit 116.

When MPEG TS, which is input from the BS/CS digital tuner 101 to IEEE 1394 interface 104, is reproduced as transmission reproduction, the PLL circuit 113, on the basis of PCR supplied from the demultiplexer 108, applies PLL on the clock of the internal VCXO (voltage control crystal) 125, generates a clock synchronizing with the clock during encoding MPEG TS (27 MHz), and supplies this to the MPEG AV decoder 109, PLL circuit 115 and PLL circuit 116 respectively as a reference clock. When the MPEG TS recorded in the recording medium is reproduced, that is when storage reproduction is performed, the PLL circuit 113 supplies the clock at the default frequency of the VCXO 125 directly to the MPEG AV decoder 109, PLL circuit 115 and PLL circuit 116 respectively as a reference clock. The reference clock switching processing of the PLL circuit 113 is controlled by a system controller 114.

The system controller 114 controls the entire recording/reproducing device, including the PLL circuit 113.

The PLL circuit 115 generates a necessary clock by synchronizing with the reference clock supplied from the PLL circuit 113 using PLL, and supplies it to the MPEG AV decoder 109, post video signal processing circuit 110, D/A conversion circuit 111 and synchronization signal generation circuit 117 respectively at predetermined timings.

The PLL circuit 116 generates a necessary clock by PLL synchronizing with the reference clock supplied from the PLL circuit 113, and supplies it as a clock for the audio signal prcessing to the MPEG AV decoder 109 and D/A conversion circuit 112 respectively at predetermined timings.

The synchronization signal generation circuit 117 generates a synchronization signal at a self-advancing cycle using the clock supplied from the PLL circuit 115, and supplies it to the MPEG AV decoder 109, post video signal processing circuit 110 and D/A conversion circuit 111 respectively at predetermined timings.

In this recording/reproducing device of the prior art, the reference clocks in the transmission reproduction and the storage reproduction are regenerated based on one VCXO clock in both cases, so even if the reproducing mode is switched, continuity of the reference clock and synchronization signal is maintained. As a result, an undisturbed image can be displayed.

However in the recording/reproducing device of the prior art, a program on a different channel broadcasted in the same slot cannot be recorded, in other words, recording another program B while watching program A is impossible. In the case of the recording/reproducing device of the prior art, there is only one reference clock, and the reference clock is synchronized with the transmission side of the viewing target stream (program A). VCXO is adjusted based on the comparison result of PCR (time information when the transmission side is encoded) included in the viewing target stream and STC in the PLL circuit, so that reference clock synchronizing with the transmission side is output, and STC ultimately becomes roughly the same as the PCR included in the viewing target stream.

If the reference clock is also synchronized with the transmission side of the recording target stream (program B), VCXO is adjusted based on the comparison result of PCR included in the recording target stream and STC in order to synchronize with the transmission side of the recording target stream. However this results in the loss of synchronization with the transmission side of the viewing target stream, and if the reference clock is synchronized with the viewing target stream, then synchronization with the transmission side of the recording target stream is lost. In the end synchronization with the transmission side is lost for both viewing and recording, the synchronization system is disabled, an image is disturbed while viewing due to the generation of an over flow or under flow in the decoder buffer, and an image may be disturbed in recording when the recorded stream is reproduced by another unit because synchronization is lost.

Therefore when a program is viewed, the reference clock must be used exclusively so as to synchronize with the transmission side of the viewing target stream (program A), and the reference clock cannot be synchronized with the recording target stream (program B), and cannot be recorded.

### SUMMARY

According to one aspect of the present invention, there is provided an information processing device comprises two or more tuners, a counter for reproduction and a counter for recording, provided for managing time for a received side, and a synchronization control section to control a reproducing clock and a recording clock for reproducing and recording received data received via the tuners respectively, so as to synchronize with a transmission side based on time information added to the received packet and a count value of the counter for reproduction or the counter for recording.

The present invention provides an information processing device having a counter for reproduction and a counter for recording, wherein a reproducing clock and recording clock are independently controlled, therefore a stream to be reproduced and a stream to be recorded can be independently synchronized. In other words, according to the present invention, an information processing device which can record another program while viewing one program can be provided.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a diagram showing an information processing device according to a first embodiment of the present invention;

FIG. 2 is a diagram showing the local buffer 24;

FIG. 3 is a flow chart showing a method for performing synchronization in the information processing device according to the first embodiment;

FIG. 4 is a diagram showing a delay time;

FIG. 5 is a diagram showing a processing route when program B is recorded while viewing program A;

FIG. 6 is a diagram showing an information processing device according to a second embodiment;

FIG. 7 is a flow chart showing a method for performing synchronization in the information processing device according to the second embodiment;

FIG. 8 is a table showing which count value of the linear counter M/R should be held;

FIG. 9 is a diagram showing a processing route of the information processing device before and after switching, and shows the status of viewing and recording program A;

FIG. 10 is a diagram showing a processing route of the information processing device before and after switching, and shows the status of recording program A and viewing program B;

FIG. 11 is a diagram showing the processing routes of the information processing device before switching;

FIG. 12 is a diagram showing the processing routes of the information processing device after switching;

FIG. 13 is a diagram showing a local buffer;

FIG. 14 is a diagram showing a local buffer when switching is instructed;

FIG. 15 is a diagram showing a relationship between the count value of the linear counter M/R and the delay time;

FIG. 16 is a diagram showing a local buffer during switching processing;

FIG. 17 is a diagram showing the processing route of the information processing device after switching;

FIG. 18 is a diagram showing the processing route of the information processing device after switching;

FIG. 19 is a diagram showing the processing route of the information processing device after switching; and

FIG. 20 is a diagram showing a recording/reproducing device disclosed in Hamada et al.

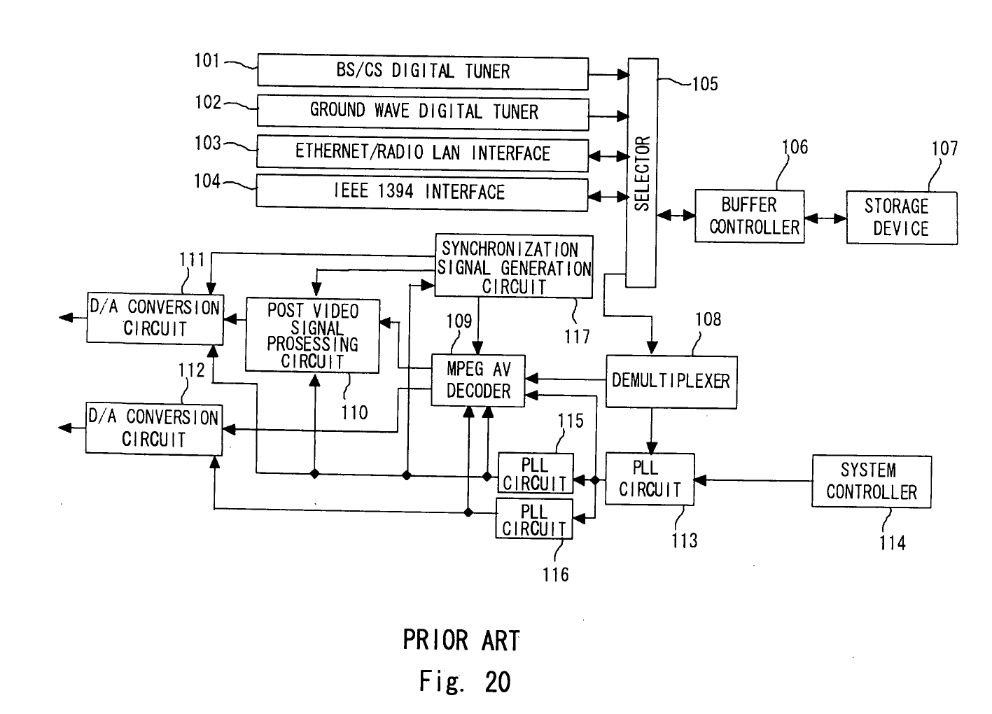

### DETAILED DESCRIPTION OF THE PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

Embodiments of the present invention will now be described with reference to the drawings. These embodiments of the present invention are applied to an information processing device (recording/reproducing device) which can record another program simultaneously while viewing (reproducing) program, or can switch a viewing target or a recording target.

### Embodiment 1

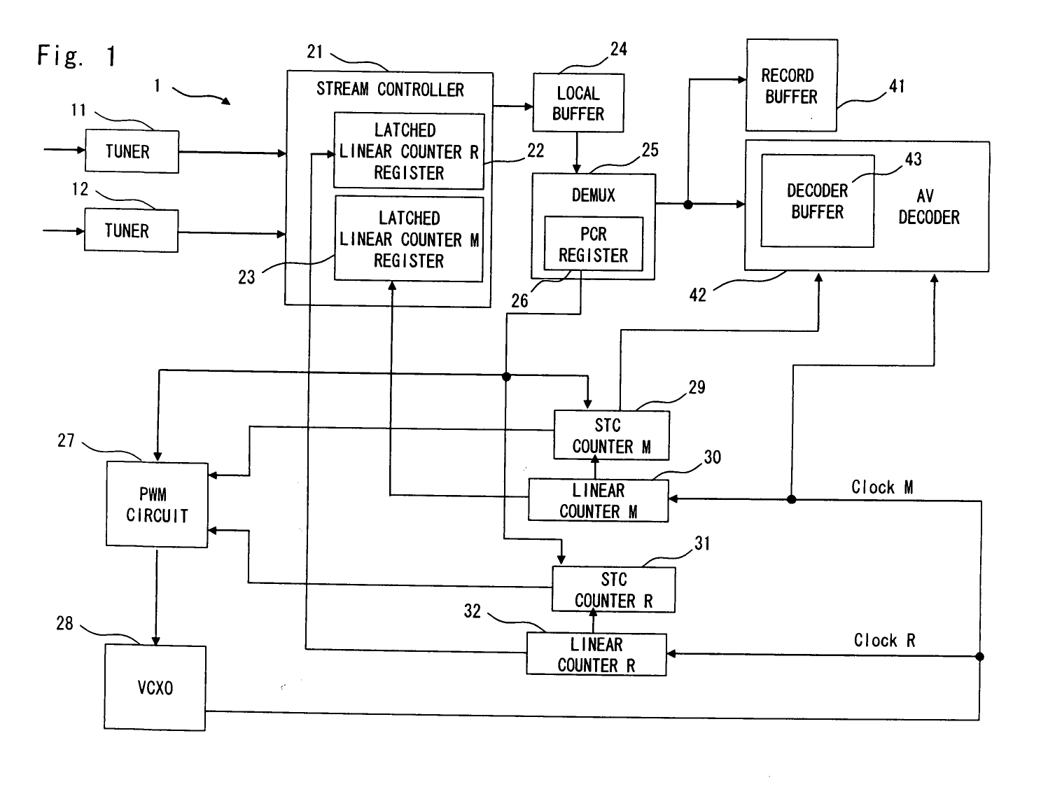

FIG. 1 is a diagram showing an information processing device according to an embodiment of the present invention. As FIG. 1 shows, the information processing device 1 comprises turners 11 and 12, a stream controller 21, local buffer 24, demux 25, pulse width modulation (PWM) circuit 27, voltage controlled Xtal oscillator (VCXO) 28, STC (System Time Clock) counter M 29, STC counter R 31, linear counter M 30, linear counter R 32, record buffer 41 and AV decoder 42.

The stream controller 21 further comprises a latched linear counter R register 22 and latched linear counter M register 23. The latched linear counter R register 22 and the latched linear counter M register 23 are registers for holding latched count values of each linear counter M 30 and R 32 when a packet arrives. The data of either the latched linear counter M register 22 or the latched linear counter R register 23 (count value of a linear counter) is stamped in a packet by the stream controller as a time stamp. Then the stream controller 21 inputs the time-stamped received data to the local buffer 24.

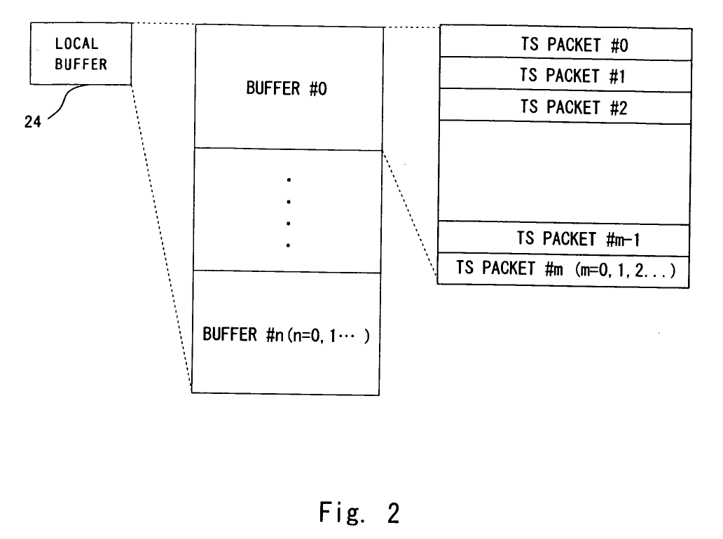

FIG. 2 is a diagram showing the local buffer 24. As FIG. 2 shows, the local buffer 24 is divided into predetermined areas, and is comprised of a plurality of buffers. Normally one buffer is allocated to one tuner. And basically one open buffer is allocated. A buffer is further divided into smaller areas, and a TS packet is held in this area. This area is a size larger than a size of a TS packet, and various management information, including a time stamp for each TS packet, is added to the TS packet and saved.

Referring back to FIG. 1, the linear counter M/R counts the number of cycles of a clock M/R. Using a count value of the linear count M30 (third count value) and a count value of the linear counter R 32 (fourth count value), the delay of the PCR is adjusted, as mentioned later.

The STC counter M 29/STC counter R 31 is a counter for managing time at the reception side, and is comprised of a 90 KHz counter and a 27 MHz counter. The 90 KHz counter is a counter which is counted up each time the 27 MHz counter counts 300, and the STC counter outputs remainders when the count value of the 90 KHz counter and the count value of the 27 MHz counter are divided by 300 as STCM (first count value) and STCR (second count value) respectively.

The PMW circuit 27 compares the STC count value and the PCR, and controls the voltage to be output based on this comparison result. PCR is information included in an adaptation field of a TS packet, and shows information on the relative transmission time of this TS packet. For example, if STC is greater than PCR, this means that the clock at the reception side is advanced compared with the clock at the transmission side. In order to synchronize, voltage is decreased to slow the clock at the reception side, or voltage is increased to quicken the clock, and outputs the voltage to the VCXO in the subsequent stage. The PWM circuit 27 constitute a synchronization control section for controlling the reproducing clock M and the recording clock R based on PCR added to the packet and the count values STC of the STC counter M 30 and STC counter R 32.

VCXO 28 is a voltage controlled oscillator (VCO) using a crystal oscillator as a resonator, and can change frequency using voltage. The VCXO 28 according to the present embodiment has VCXOs for reproducing and recording for outputting a 27 MHz reproducing clock M and recording clock R based on the voltage sent from the PWM circuit 27. Since clock M is for viewing and clock R is for recording, and viewing and recording are exclusively and independently synchronized, another program can be recorded while viewing a program.

Record buffer 41 is a buffer for recording data, and buffers recording data.

The demux 25 performs such processing as analysis, demultiplexing and synchronization for the data held in the local buffer 24. The demux 25 also performs delay calculation for adjusting the delay of PCR using a count value of the linear counter M 30/R 32. Delay calculation will be described in detail later. This processing of the demux is executed by a CPU (Central Processing Unit), which is in-charge of the functions of the demux.

The tuner 11 and the tuner 12 receive the digital broadcast sent from the ground wave digital tuner, BS/CS broadcast satellite or communication satellite. The received packet data is supplied to the local buffer 24 by the stream controller 21. The packet data held in the local buffer 24 is subject to such processing as analysis, demultiplexing and synchronization by the demux 25, and is sent to the AV decoder 42.

Of the data sent from the demux 25 to the AV decoder 42, video data is sent to a video decoder, and voice data is sent to an audio decoder. The video decoder and audio decoder perform decoding while maintaining timing with the clock M. To record packet data, the packet data is sent to the record buffer 41, and is then sent to a storage device, such as an HDD (Hard Disk Drive) and DVD (Digital Versatile Disc), which are not illustrated.

For this, clock M is supplied to the AV decoder 42. In the present embodiment, the AV decoder 42 always maintains decoding timing by checking the clock M, and never maintains decoding timing by the clock R instead of the clock M. If the clock is changed, timing cannot be maintained during switching, and accurate decoding may not be performed.

The STC counter M 29, STC counter R 31, linear counter M 30, linear counter R 32, latched linear counter R register 22, latched linear counter M register 23, PWM circuit 26 and VCXO 27 are hard ware used for synchronizing with the transmission side.

The synchronization system of the transmitter/receiver is defined by standards, where the transmission station side inserts the time information at encoding as PCR, the reception side compares the STC in the receiver and PCR, and adjusts the reference clock based on the comparison result to synchronize.

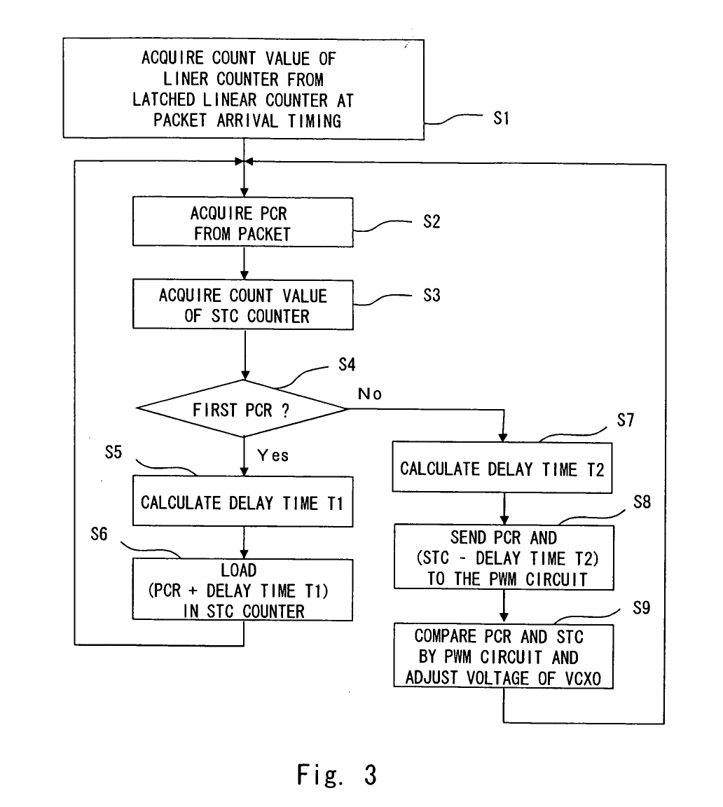

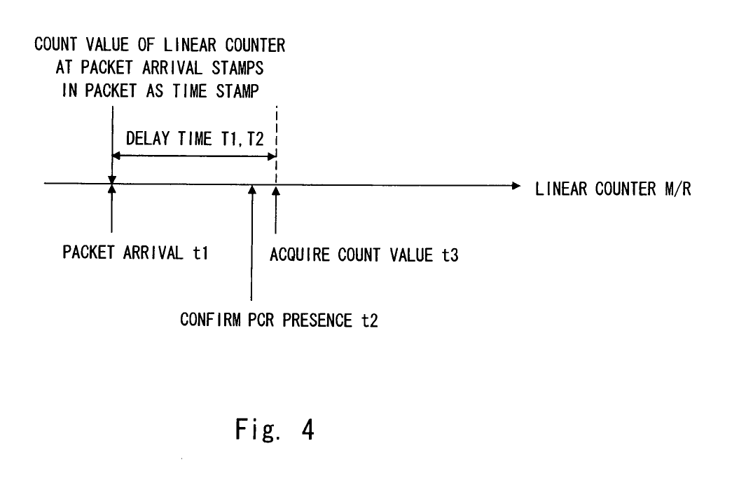

Now a method for performing synchronization in this information processing device will be described. FIG. 3 is a flow chart showing a method for performing synchronization in the information processing device 1 according to the present embodiment. FIG. 4 is a diagram showing a delay time. Here a method for synchronizing and viewing data, which was received by the tuner 11 using the STC counter M 29 and linear counter M 30, will be described to simplify description. A packet received by the tuner 11, where a count value of the liner counter M 30 for viewing is stamped by the stream controller 21 as a time stamp at packet arrival, is held in the local buffer 24. The demux 25 checks if PCR is included in the packet, and holds the PCR, which is detected first, in the PCR register 26 and also sends it to the STC counter M 29. The STC counter M 29 loads this PCR as an initial value. In this case, a delay is generated from the arrival of the PCR to the detection of the PCR, so a PCR considering delay, that is a PCR of which delay has been adjusted, must be loaded in the STC counter 29. The delay time T1 for this delay adjustment is calculated by the following Formula (1) (step S5).

Delay time T1=linear counter count value acquired just before loading PCR−linear counter count value when packet acquired from the latched linear counter arrived (1)

As FIG. 4 shows, if the timing when a packet to which PCR is attached arrives is t1, the timing when the presence of PCR is confirmed is t2, and the timing when the count value of the linear counter M 30 immediately after t2 is acquired is t3, then delay time T1, which is t3−t1, is generated at the point when PCR is loaded in the STC counter M 29. So the demux 25 acquires a count value of the liner counter M 30 at the packet arrival timing t1, which is held in the latched linear counter M register 23 (step S1), acquires the PCR held in the PCR register 26 (step S2), and acquires a count value of the STC counter M 29 (step S3).

In this case, the acquired PCR is the first PCR (step S4: YES), and the above mentioned delay time T1 is calculated. Then (PCR+delay time T1) is loaded in the STC counter M 29 as an initial value.

After PCR is loaded, if the PCR is detected, a count value of the STC counter M 29 and PCR are compared by the PWM circuit 27. In this case, time from the arrival of the packet, including the PCR, to the detection of the PCR (delay) must be considered, as mentioned above, that is the PCR and STC of which delay is adjusted, must be compared. The delay time T2 for this delay adjustment is given by the following Formula (2).

Delay time T2=linear counter count value acquired just before acquiring the STC count value−linear counter count value when the packet, which is acquired from the latched linear counter, arrived (2)

Again as FIG. 4 shows, the delay time T2 is a value resulting when a count value of the linear counter M 30 at timing t1, when a packet to which PCR is attached arrives, is subtracted from a count value of the linear counter M 30 acquired at timing t3.

The demux 25 acquires a count value of the linear counter M 30 at the packet arrival timing t1 held in the latched linear counter M register 23 (step S1), acquires the PCR held in the PCR register 26 (step S2), and acquires a count value of the STC counter M 29 (step S3). Then processing advances to step S7, and the demux 25 calculates delay time T2 and sends STCM−delay time T2, where STCM is the count value of the STC counter M read in step S3, to the PWM circuit 27 along with PCR (step S8). The PWM circuit 27 compares PCR and the delay-adjusted STC (STCM−delay time T2), and adjusts the voltage of the VCXO 27 based on this comparison result. By this, the clock M is adjusted and synchronized with the transmission side.

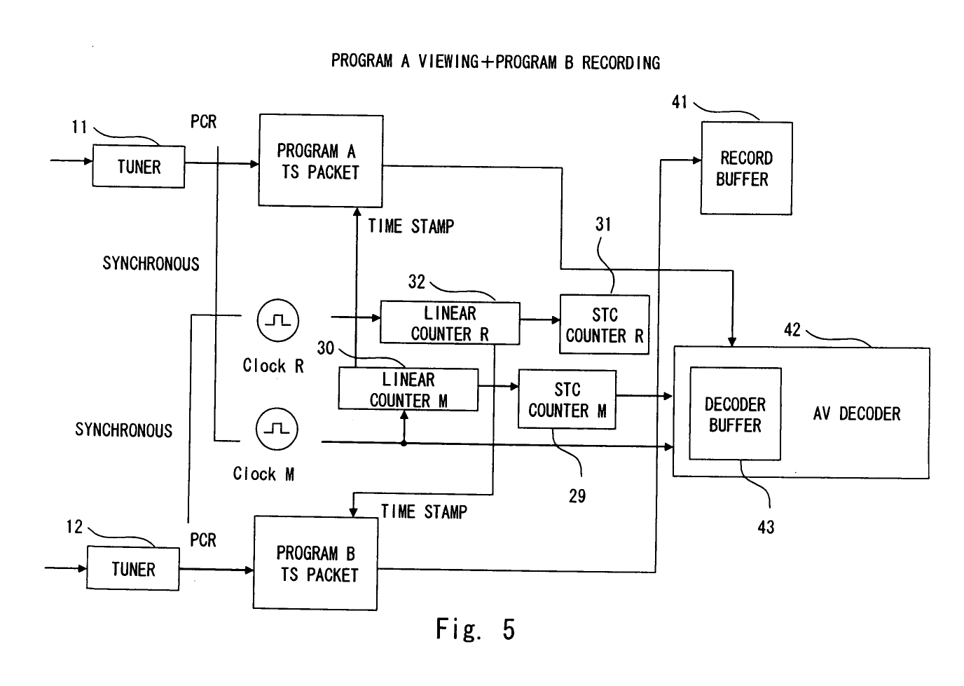

FIG. 5 is a diagram showing a processing route when program B is recorded while viewing program A. Since there are two clocks, a clock M for viewing (reproduction) and a clock R for recording, each clock M/R can be synchronized even if the respective input is different. A route of sending record buffer 41 a packet of program A, which is synchronized with the transmission side, to the AV decoder 42, and a route of sending to the record buffer 41 a packet of program B, which is also synchronized with the transmission side, can be established independently from each other, and simultaneous viewing and recording, which a information processing device of the related art cannot perform, can be implemented.

In the present embodiment, synchronization can be exclusively and independently performed for viewing and recording by using two dedicated clocks, one for viewing and the other for recording, so another program can be recorded while viewing another program.

### Embodiment 2

Embodiment 2 of the present invention will now be described. The present embodiment is a device where there is only one latched linear counter in stream control, so as to reduce circuit scale. In Embodiment 1, the latched linear counter M register for viewing and the latched linear counter R register for recording are provided for each tuner, but in the present embodiment, a common latched linear counter register is provided for both viewing and recording for each tuner. As a result, the number of latched linear counter registers becomes half, and circuit scale is reduced.

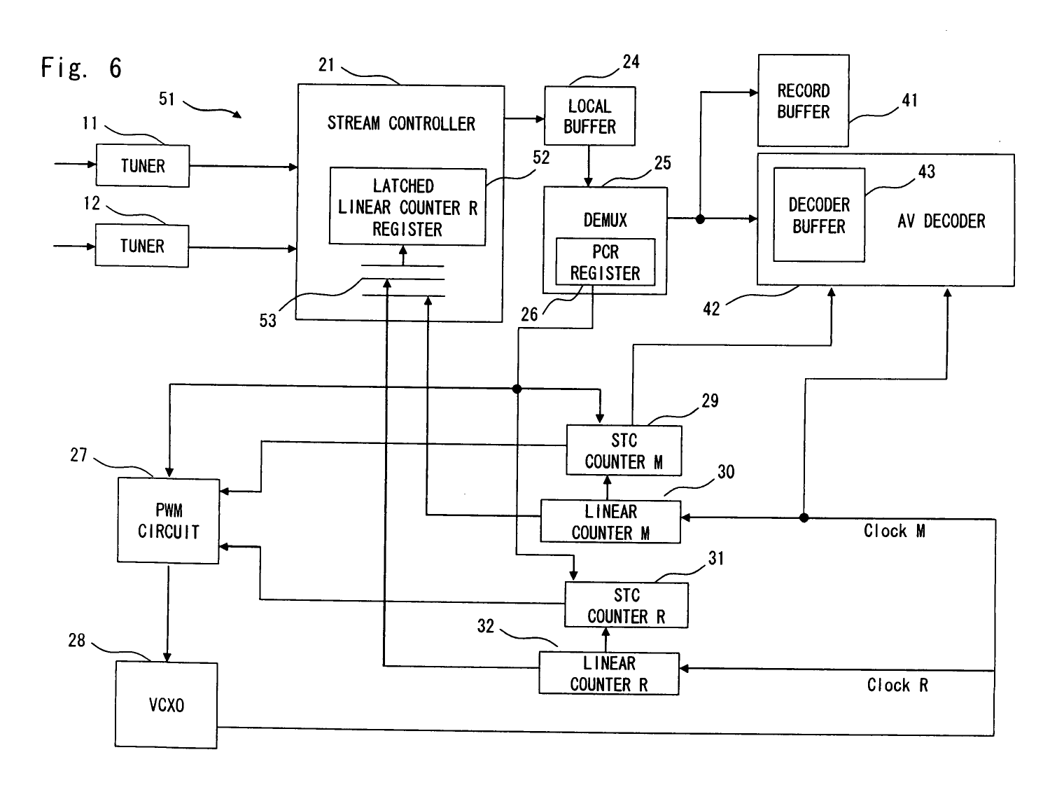

FIG. 6 is a diagram showing an information processing device according to the present embodiment. As FIG. 6 shows, the information processing device 51 according to the present embodiment has a latched linear counter register 52 and a selector 53. According to the instruction from a stream controller 21, the selector 53 selects a linear counter M 30 or a linear counter R 32, and the latched linear counter register 52 latches a counter value (fifth counter value) selected by the selector 53. Then the data held in the latched linear counter register 52 (count value of the linear counter M 30 or linear counter R 32) is stamped in the packet by the stream controller 21 as a time stamp. The rest of the configuration is the same as the information processing device 1 in FIG. 1.

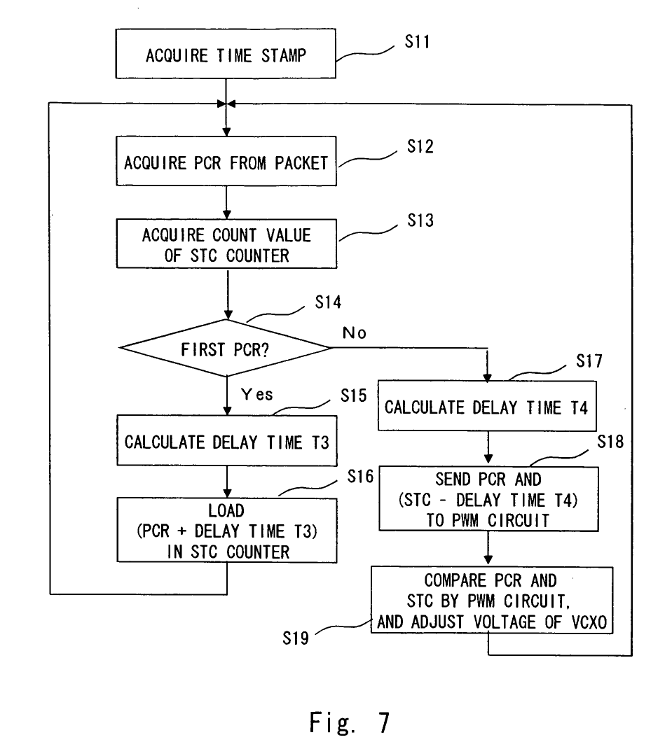

A method of performing synchronization in this information processing device 51 will now be described. FIG. 7 is a flow chart showing a method for performing synchronization in the information processing device according to the present embodiment. Here a method for synchronizing and viewing data, which was received by the tuner 11, using the STC counter M 29 and the linear counter M 30, will be described to simplify description. A packet received by the tuner 11, where a count value of the linear counter M 30 is stamped by the stream controller 21, as a time stamp at packet arrival, is held in the local buffer 24.

The demux 25 checks if PCR is included in the packet, and holds the PCR, which is detected first, in the PCR register 26, and also sends it to the STC counter M 29. The STC counter M 29 loads this PCR as an initial value. In this case, a delay is generated from the arrival of the PCR to the detection of the PCR, so considering this delay, the PCR of which delay has been adjusted must be loaded in the STC counter M 29. The delay time T3 for this delay adjustment is calculated by the following Formula (3).

Delay time T3=linear counter count value acquired just before loading PCR−time stamp (3)

In other words, the demux 25 acquires a time stamp stamped in the packet where the PCR is included (step S11), acquires the PCR held in the PCR register 26 (step S12), and acquires a count value of the STC counter M 29 (step S13).

In this case, the acquired PCR is the first PCR (step S14: YES), so the delay time T3 is calculated. Then (PCR+delay time T3) is loaded in the STC counter M 29.

After PCR is loaded, if PCR is detected, a count value of the STC counter 29 and PCR are compared by the PWM circuit 27. In this case, the time from the arrival of the packet, including the PCR, to the detection of the PCR (delay) must be considered, as mentioned above, and the PCR and STC of which delay is adjusted must be compared. The delay time T4 for this delay adjustment is calculated by the following Formula (4).

Delay time T4=linear counter count value acquired just before acquiring the STC count value−time stamp (4)

As described above, the demux 25 acquires a time stamp stamped in the packet including the PCR (step S11), acquires the PCR held in the PCR register 26 (step S12), and acquires a count value of the STC counter M 29 (STCM) (step S13). Then the processing advances to step S17, where the demux 25 calculates the delay time T4, determines the STCM−delay time T3 based on the count value STCM which was read in step S13, and sends this delay-adjusted STC to the PWM circuit 27 along with PCR (step S8). The PWM circuit 27 compares the PCR and the delay-adjusted STC (STCM−delay time T3), and adjusts the voltage of the VCXO 27 based on this comparison result. By this, the clock M is adjusted and synchronized with the transmission side.

In the case of the information processing device 51 according to the present embodiment, the latched linear counter register is shared for recording and viewing, so only one of the count value of the linear counter M 30 and the count value of the linear counter R 32 can be held. Therefore only one of the count values of the linear counter M 30 and the linear counter R 32 can be held as the packet arrival time information=time stamp.

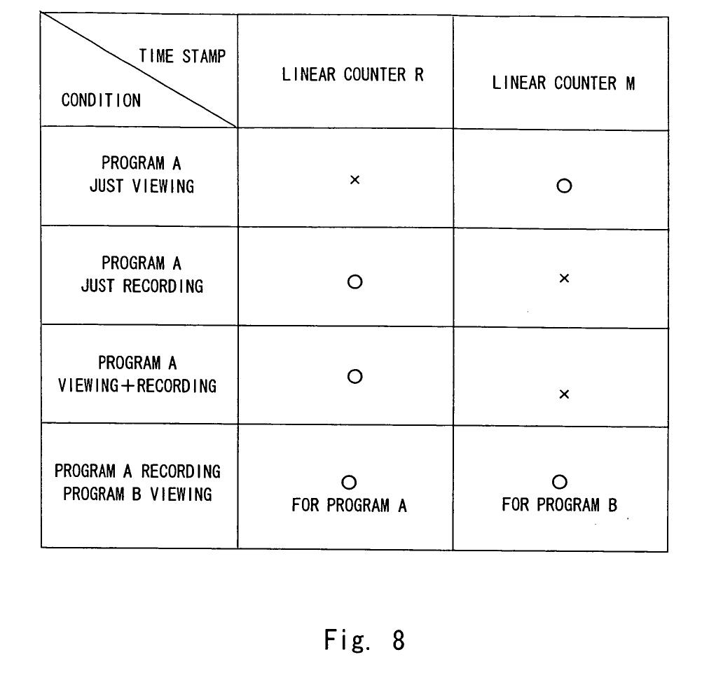

In other words, if there are two latched linear counter registers, both count values of the linear counter R and the linear counter M can be held, and one of them can be selected and stamped in the packet as a time stamp. If there is one latched linear counter register, as in the case of the present embodiment, only one count value is held, so a count value to be stamped cannot be selected, but a count value selected by the selector 53 becomes the time stamp. In this case, it must be judged which count value of the linear counter M 30 and linear counter R 32 is held in advance. FIG. 8 is a table showing which count value of the linear counter M/R should be held.

FIG. 8 shows an example when program A is received from the tuner 11 and program B is received from the tuner 12. As FIG. 8 shows, basically the linear counter M 30 is for viewing and the linear counter R 32 is for recording, but if one program is viewed and also recorded, the count value of the linear counter R 32 for recording is held. Therefore in this case, data where the count value of the linear counter R 32 is time-stamped is also used for viewing.

Now the data to be held in the latched linear counter register 52 for viewing, for recording and for viewing and recording will be described in detail. As mentioned above, in order to synchronize with the transmission side, the received side compares the count value of the STC and PCR, adjusts the amplitude of the VCXO based on this comparison result, and adjusts the clock M/R. For the count value of the STC to be used for comparison, the count value of STC, when a packet including the PCR, arrives at the received side. In reality, however, a delay time is generated, as mentioned above.

As mentioned above, the delay time is determined by subtracting a count value of the linear counter when the packet arrives from a count value of the linear counter when the STC count value is acquired. When the received side performs synchronization with the transmission side:
a count value of either the linear counter R or the linear counter M is used for the time stamp,
STC and PCR are compared, and the clock is adjusted based on the comparison result, and,

the delay time must be subtracted from the STC.

According to the above three points, the linear counter M 30 is used for the time stamp in the case of viewing only, since synchronization must be performed only for the viewing synchronization route (clock M). In other words, the selector 53 selects the linear counter M 30, and the latched linear counter register 52 latches the count value of the linear counter M 30.

In the case of recording only, the linear counter R32 is used for the time stamp, since synchronization must be performed only for the recording synchronization route (clock R). In other words, the selector 53 selects the linear counter R 32, and the latched linear counter register 52 latches a count value of the linear counter R 32.

In the case of viewing and recording program A, both clock M and clock R must be synchronized with the transmission side of program A. For this synchronization, the delay time must be determined, but only one count value of a linear counter can be latched for each tuner, so calculation must be performed using a count value of either the linear counter R 32 or the linear counter M 30.

If the delay time is determined using the linear counter R 32, for example, this delay time is used not only for synchronization of the clock R, but also for synchronization of the clock M. If a target program is the same for both viewing and recording, controlling the synchronization of clock M using the linear counter R 32 is allowed, since errors from the delay time, when the linear counter M 30 is used, is small.

For recording, a time stamp synchronized with the transmission side of the recording target program must be stamped continuously. To satisfy this condition, the linear counter R 32 must be used. Therefore if program A is viewed and also recorded, a count value of the linear counter R 32 must be used, as shown in FIG. 8.

Depending on the status, such as viewing, recording and program change, various patterns are used for the switching operation. As mentioned above, in the present embodiment, there is only one common latched linear counter register 52 that is shared for viewing and recording for each tuner. Therefore a predetermined switching processing requires processing to switch a count value, to be latched to the latched linear counter register 52, to either one of the linear counters M 30 and R 32. This switching processing will now be described in detail.

In the case of viewing, recording or viewing and recording, the linear counter to be used for a time stamp may have to be switched when the viewing target or recording target is switched, so that both viewing and recording can be operated normally even if the viewing target or the recording target is switched. In this case, switching processing, where no synchronization processing is performed until the packets in the local buffer become only packets which are time-stamped by the linear counter after switching, is required.

In the following description, a typical operation, out of the operations for switching recording and viewing using one or two tuners, will be described. In the information processing device according to the present embodiment, it is assumed that the simultaneous viewing or recording of two programs is not performed. It is also assumed that program A is received from the tuner 11, and program B is received from the tuner 12.

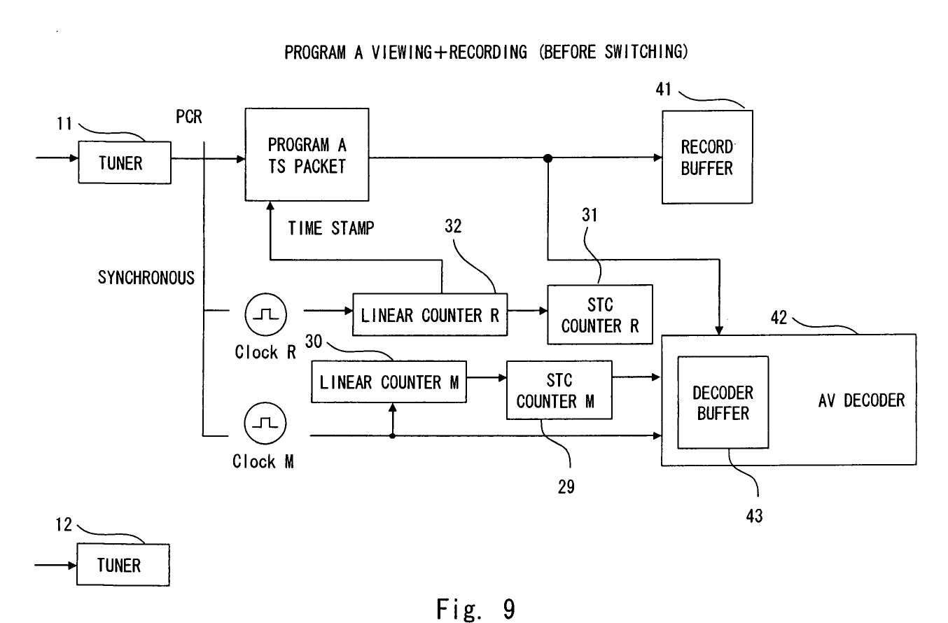

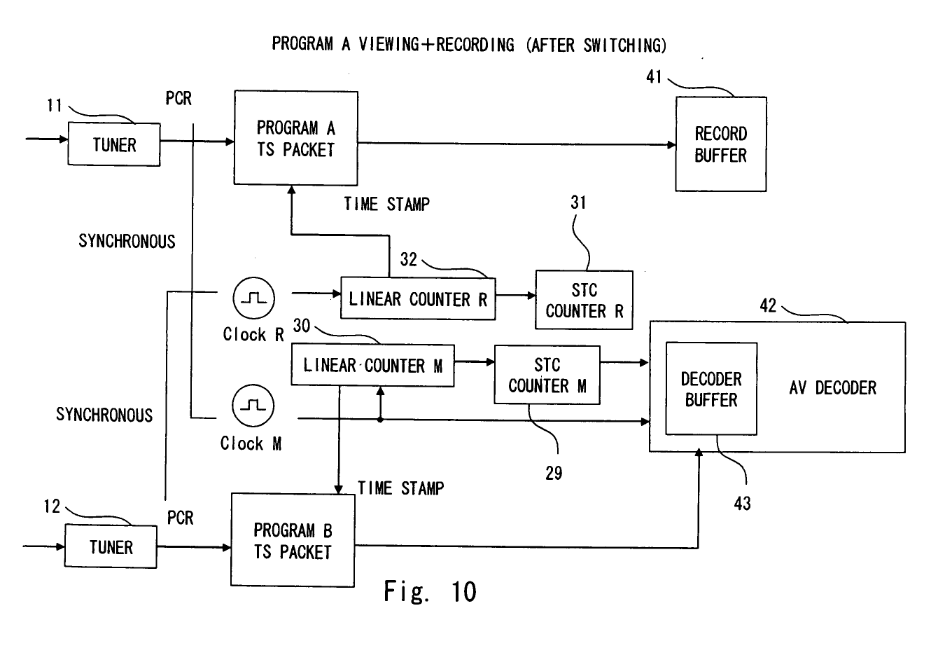

First a case when the above mentioned switching processing is not required will be described. The following description is a case when a user who is viewing+recording program A switches the viewing target to program B, while continuously recording program A. FIG. 9 is a diagram showing a processing route of the information processing device before and after switching, and shows the status of viewing and recording program A, and FIG. 10 is a diagram showing a processing route of the information processing device before and after switching, and shows the status of recording program A and viewing program B.

In this case, for viewing, program B and clock M are synchronized, and for recording, program A is continuously recorded. For the recording processing, it is necessary to stamp a time stamp that is synchronized with program A, and the linear counter, which is referred to when the time stamp is stamped, must not be changed in the middle of recording in order to maintain continuity of the time stamp. Therefore in the case of viewing+recording program A, the linear counter R must be used for stamping the time stamp (see FIG. 9).

After the viewing target is switched to program B, a new route to perform synchronization to view program B is added to the route for recording program A continuously and stamping the synchronized time stamp, as shown in FIG. 10. For this switching processing, the count value of the linear counter R32, latched by the latched linear counter register 52 corresponding to the tuner 12, is time-stamped for program B received by the tuner 12, so there is no problem in the switching processing.

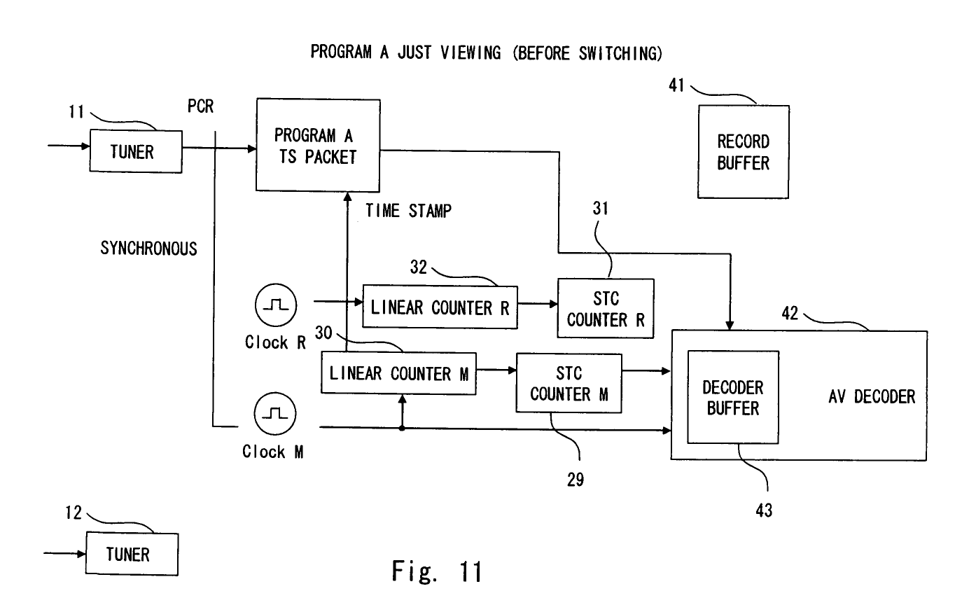

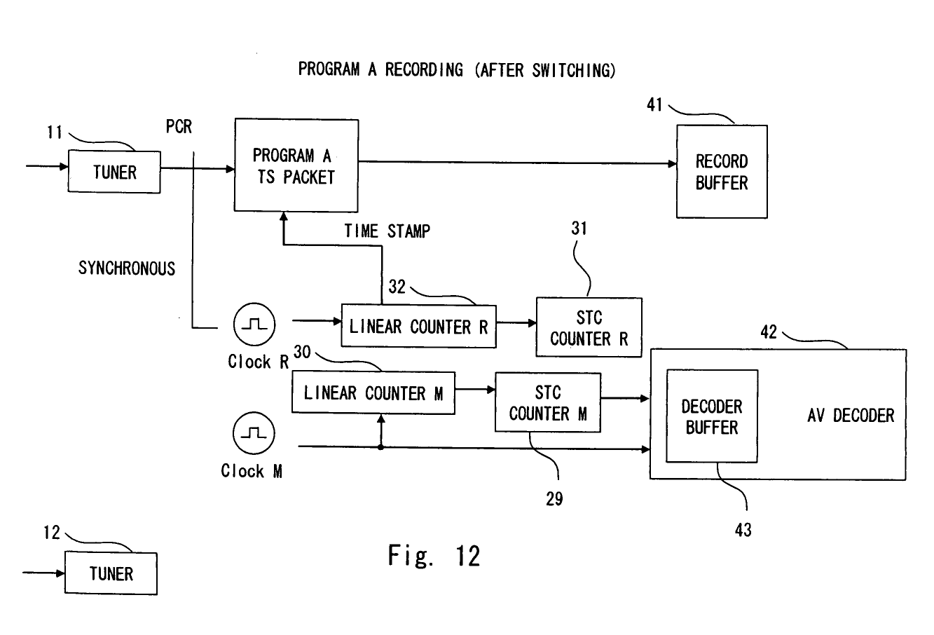

Now the case when the above switching processing is required will be described using a typical switching operation as an example. First a case of viewing program A and then recording program A by a switching instruction will be described. FIG. 11 and FIG. 12 are diagrams showing the processing routes of the information processing device before and after switching. As FIG. 11 shows, if program A is being viewed at the beginning, a time stamp is stamped based on the count value of the linear counter M 30. Then if this is switched and program A is recorded, a time stamp is stamped based on the count value of the linear counter R 32.

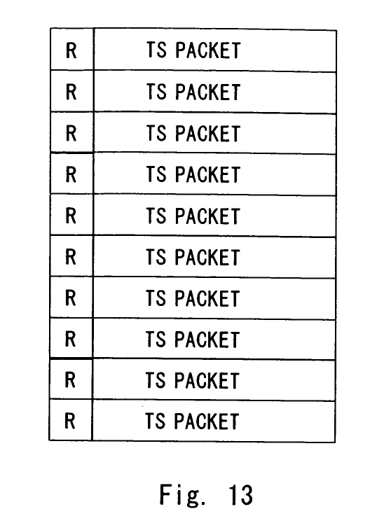

FIG. 13 shows a local buffer. Packets are sent from a broadcasting station with a predetermined interval, but the demux 25 is not synchronized with the speed of analysis and demultiplexing, so the local buffer 24 can temporarily hold an arbitrary number of packets, such as ten as shown in FIG. 13.

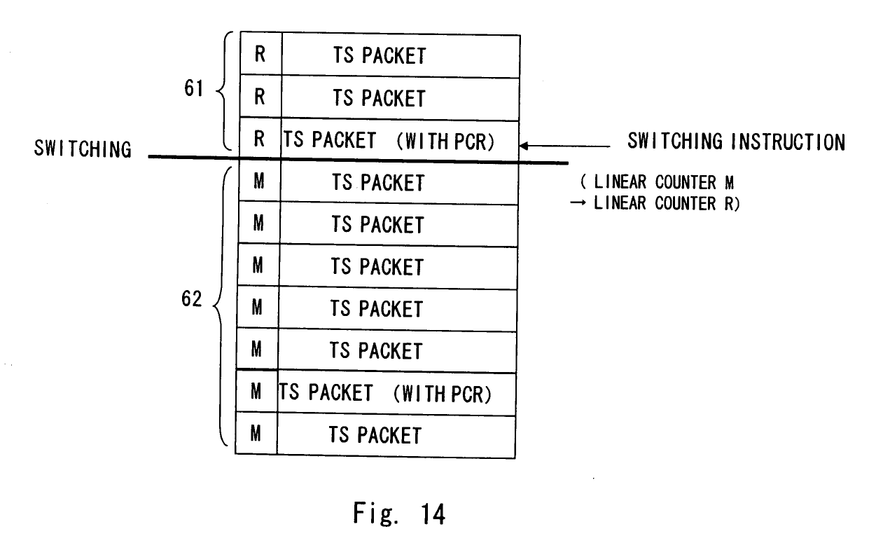

FIG. 14 shows a local buffer when switching is instructed. For packets which were sent before switching, a count value of the linear counter M 30 is stamped as a time stamp, but in the case of synchronizing with packets after switching, the time stamp of the packet 62 after a switching instruction is a count value of the linear counter R 32, but the time stamp of the packet 61 before a switching instruction is not a count value of the linear counter R 32, but a count value of the linear counter M 30 as shown in FIG. 14.

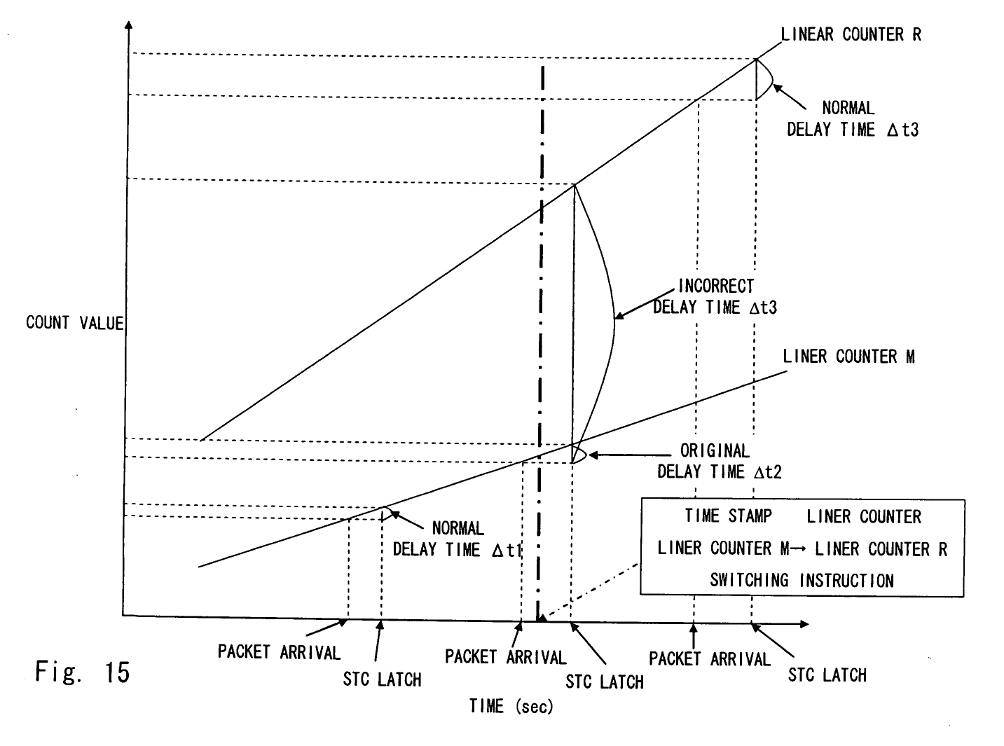

The demux 25 calculates the delay time T4 by (count value of linear counter acquired just before acquiring the STC count value−time stamp). In this case, for the packet 61 after a switching instruction, the count value of the linear counter acquired just before acquiring the STC count value is a count value of the linear counter R 32, and the time stamp is not the count value of the linear counter R 32, but a count value of the linear counter M 30. Therefore a count value of a different linear counter is used in the delay calculation, which may make the delay time incorrect. FIG. 15 is a diagram showing a relationship between the count value of the linear counter M/R and the delay time. As FIG. 15 shows, it is possible that the comparison result of PCR and STC becomes incorrect, and synchronization is lost. In other words, for the packet 61, the time stamp is the count value of the linear counter M 30, so the delay time becomes not the original delay time Δt2, but an incorrect delay time Δt3.

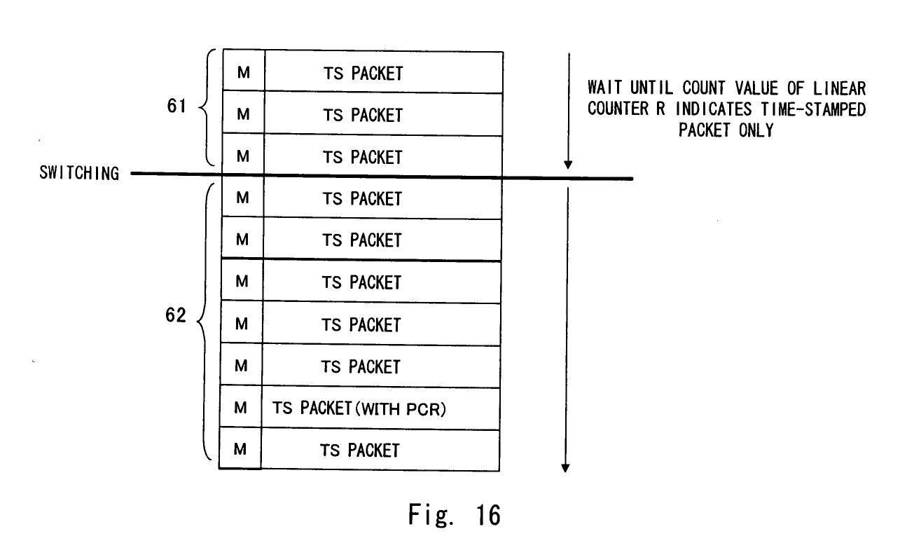

FIG. 16 shows a local buffer during switching processing. As FIG. 16 shows, the demux 25 executes processing for performing synchronization after new packets are sent after the switching point, and only packets 62 in which the count value of the linear counter R 32 is stamped exist in the local buffer 24. By this, the linear counter of the count value acquired just before acquiring the STC count value and the linear counter which acquired the count value of the time stamp become the same, and the delay time becomes the original delay times Δ1 and Δ2.

This case was described assuming that viewing program A via the tuner 11 is switched to recording program A by a switching instruction, but the same operation can be used for receiving and recording program B via the tuner 12 while viewing program A, or for receiving and viewing program B via the tuner 12 after switching. The switching operation has a transition state, and the above switching processing may not be required depending on the transition state. For example, when viewing program A is switched to recording program A and viewing program B by a switching instruction, processing basically the same as above is required. In other words, in the case of the transition of viewing program A→viewing+recording program A→recording program A+viewing program B, the above mentioned switching processing is required. Whereas in the case of the transition of viewing program A→viewing program B→recording program A+viewing program B, that is, in the case when the transition of viewing program A→recording program A does not occur, the above mentioned switching processing is unnecessary.

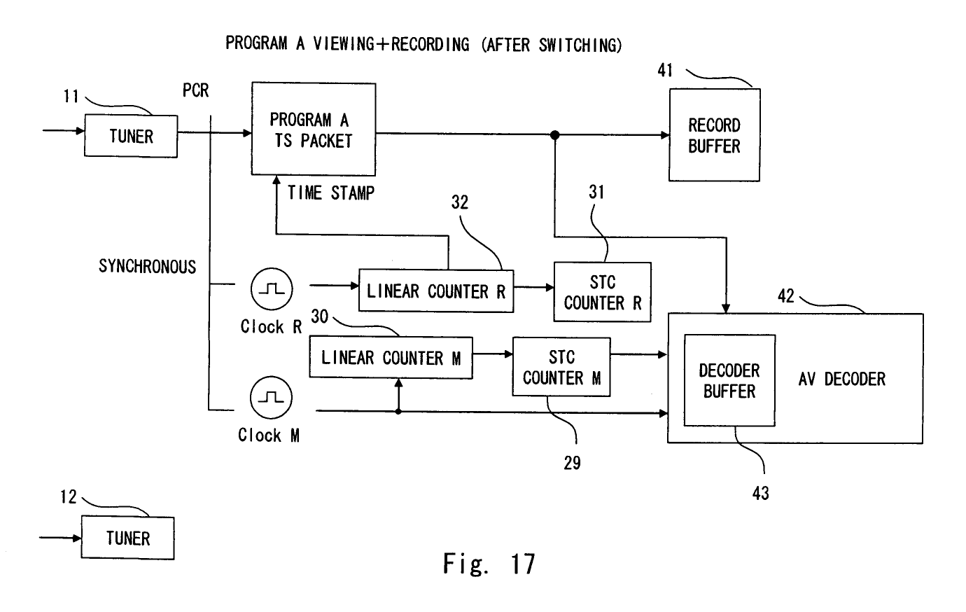

Now the case of switching from viewing program A to viewing+recording program A by a switching instruction will be described. Here this case and the above mentioned switching operation from viewing program A to recording program A are described separately, but the transition of viewing program A→recording program A is the same operation as the transition of viewing program A→viewing+recording program A→recording program A. FIG. 17 is a diagram showing the processing route of the information processing device after switching. Even in the case of stopping viewing or changing the viewing target program in the middle of recording, the time stamps synchronized with program A must be stamped in the recording processing, and the continuity of the time stamps must be maintained, so the linear counter used for time stamping must be switched from the linear counter M 30 to the linear counter R 32.

In this case as well, the time stamp of a packet held in the local buffer 24 is changed at the point of the switching instruction, from the count value of the linear counter M 30 to the count value of the linear counter R 32, so an incorrect delay time is calculated, just like the above mentioned case. Therefore in this case as well, synchronization processing is executed for viewing and recording when new packets begin to be sent after the switching, and all packets existing in the local buffer 24 become packets where the count value of the linear counter R 32 is stamped.

This processing is the same for the case of switching viewing+recording program A to stopping recording and only viewing program A by a switching instruction. Before switching, the count value of the linear counter R 32 is stamped as a time stamp, and after switching, the count value of the linear counter M 30 is stamped as a time stamp, so the synchronization processing is executed after the packets in the local buffer 24 are switched to packets stamped by the count value of the linear counter M 30.

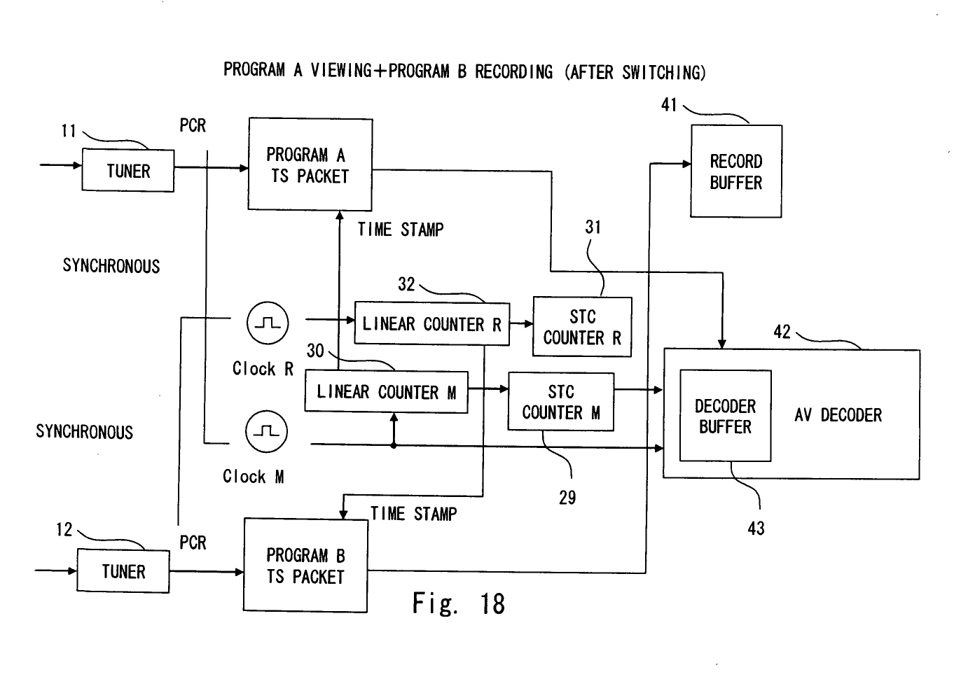

Now the case of the user switching viewing+recording program A to viewing program A and recording program B will be described. FIG. 18 is a diagram showing the processing route of the information processing device after switching. Before switching, the count value of the linear counter R 32 is time-stamped, as shown in FIG. 9. Synchronization must be maintained to continually view program A after a switching instruction, but the linear counter R 32 is now used as a new synchronization route to record program B, so a linear counter to be used for time stamping in the synchronization route for viewing program A must be switched from the linear counter R 32 to the linear counter M 30, as shown in FIG. 18.

In this case as well, the time stamp of the packets held in the local buffer 24 is changed at the point of the switching instruction, from the count value of the linear counter R 32 to the count value of the linear counter M 30, so an incorrect delay time is calculated, just like the above mentioned case. Therefore in this case as well, synchronization processing for viewing is executed when new packets begin to be sent after switching, and all packets existing in the local buffer 24 become packets where the count value of the linear counter M 30 is stamped. This is the same for the case of switching viewing program A and recording program B to viewing+recording program A.

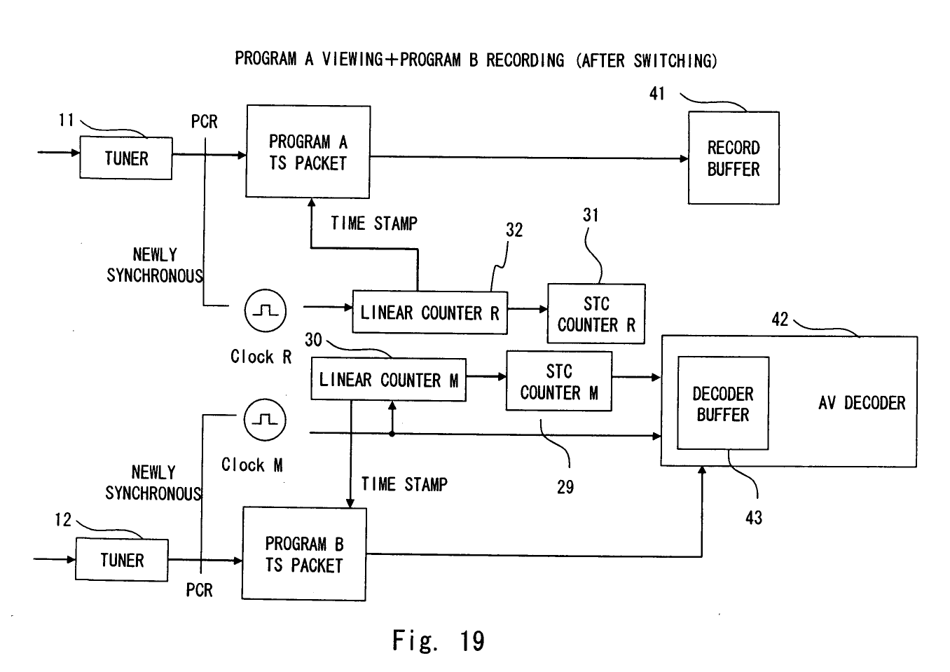

Now the case of the user switching from viewing program A and recording program B to recording program A and viewing program B by a switching instruction will be described. FIG. 19 is a diagram showing the processing route of the information processing device after switching. Since the linear counter is changed according to the time stamp of the packet held by the local buffer 24 corresponding to the tuner 11 and tuner 12 respectively, program A is recorded and program B is viewed after only new packets begin to be sent to the local buffer 24 by a switching instruction, just like the above mentioned case.

In the present embodiment, synchronization can be performed exclusively and independently for viewing and recording by using the two clocks dedicated for viewing and for recording, so one program can be recorded while viewing another. Also by installing one latched linear counter register 52 for each tuner, the circuit scale can be reduced. If the linear counter used for a time stamp is changed after switching processing, the switching processing to perform synchronization processing is executed after the packets held in the local buffer 24 are replaced, therefore an accurate delay time can be maintained, and even if the viewing target or the recording target is replaced when viewing and recording are operating simultaneously, both viewing and recording can be operated normally.

It is apparent that the present invention is not limited to the above embodiments, but may be modified and changed without departing from the scope and spirit of the invention.

For example, the above embodiments were described using a hardware configuration, but the present invention is not limited to this, but an arbitrary processing may be implemented by a CPU (Central Processing Unit) executing a computer program. In this case, the computer program can be provided by being recorded in a recording medium, or can be provided by being transmitted via the Internet or other transmission media.

What is claimed is:

1. An information processing device, comprising:
two or more tuners;
a counter for reproduction and a counter for recording, provided for managing time for a received side; and
a synchronization control section to control a reproducing clock and a recording clock for reproducing and recording received data received via the tuners respectively, so as to synchronize with a transmission side based on time information added to the received packet and a count value of the counter for reproduction or the counter for recording.

2. The information processing device according to claim 1, comprising, for each of the tuner, a stream controller comprising a register for reproduction and a register for recording to store count values of the clock for reproduction and the clock for recording as a first count value and a second count value respectively, wherein
when count values that are output by the counter for reproduction and the counter for recording are a third count value and a fourth count value respectively, the synchronization control section adjusts the delay of the third and fourth count values using the first and second count values respectively, and controls the reproducing clock and the recording clock based on the delay-adjusted third and fourth count values and the time information.

3. The information processing device according to claim 2, wherein when a received packet to which the time information is added is first received, a delay of this time information is adjusted using the first and second count values counted at the time when the received packet has arrived, and the initial values of the counter for reproduction and the counter for recording are set based on this delay-adjusted time information.

4. The information processing device according to claim 1, comprising, for each of the tuners, a stream controller having a register for storing a count value of the clock for reproduction or a count value of the clock for recording as a fifth count value, wherein
the stream controller stamps the fifth count value stored in the register in a received packet as a time stamp, and
the synchronization control section adjusts the delay of the third and fourth count values by the time stamp using a third and a fourth count values respectively, where the third and fourth count values are count values which are output by the counter for reproduction and the counter for recording respectively, and controls the reproducing clock and the recording clock based on the delay-adjusted third and fourth count values and the time information.

5. The information processing device according to claim 4, wherein when a received packet to which the time information is added is first received, the delay of this time information is adjusted using the fifth count value counted at the time when the received packet has arrived, and the initial values of the counter for reproduction and the counter for recording are set based on this delay-adjusted time information.

6. An information processing device, comprising:
two or more tuners;
a first counter;
a second counter; and
a synchronization control section to control a first clock for playing or recording received data received via the tuner, based on time information included in the received packet and a first count value output from the first counter, and to control a second clock for playing or recording received data received via the tuner, based on the time information and a second count value output from the second counter.

7. The information processing device according to claim 6, wherein
the synchronization control section controls the first clock based on the time information and a third count value obtained by adjusting the delay by using a value output from the first counter, and controls the second clock based on the time information and a fourth count value obtained by adjustment of the delay by using a value output from the second counter.

8. The information processing device according to claim 7, wherein when a received packet to which the time information is included is received for the first time, the synchronization control section adjusts the delay of this time information by using the first count value and the second count value at the time of the arrival of the received packet, and sets the initial value to the first counter and the second counter based on the delay-adjusted time information.

9. The information processing device according to claim 6, comprising, for each of the tuners, a stream controller comprising a register for storing the count value of either the first clock or the second clock as a fifth count value, wherein
the stream controller stamps the fifth count value stored in the register in a received packet as a time stamp, and
the synchronization control section controls the first clock based on the time information and a third count value output from the first counter obtained by adjustment of the delay by using the time stamp, and controls the second clock based on the time information and a fourth count value output from the second counter obtained by adjustment of the delay by using a value output from the second counter.

10. The information processing device according to claim 9, wherein when a received packet to which the time information is included is received for the first time, the synchronization control section adjusts the delay of this time information by using the fifth count value at the time of the arrival of the received packet, and sets the initial value to the first counter and the second counter based on the delay-adjusted time information.
